(19) United States
(12) Patent Application Publication
(10) Pub. No.: US 2011/0032830 A1
(43) Pub. Date: Feb. 10, 2011

(54) Live Router Migration

(76) Inventors: Jacobus Van Der Merwe, Union County, NJ (US); Yi Wang, Sunnyvale, CA (US)

Correspondence Address: AT&T LEGAL DEPARTMENT - Koba;ATTN: PATENT DOCKETING, ROOM 2A-207, ONE AT&T WAY, BEDMINSTER, NJ, 07921, US

(21) Appl. No.: 12/536,610

(22) Filed: Aug. 6, 2009

(51) Int. Cl. H04L 12/26; H04L 12/28

(52) U.S. Cl. 370/251; 370/401

(57) ABSTRACT

Live router migration is implemented by separating the logical features of a virtual router from its physical features. Tunnels are established between a source (physical) router and a destination (physical) router, allowing the control plane of the virtual router being migrated to send and receive messages from the destination router. The control plane information is then transferred to the destination router, which functions to clone the data plane at the destination router. Outgoing links from the destination router are then be established. The double appearance of the data plane at both the source and destination routers allows for the data plane information to be transferred asynchronously over to the destination router. Once all of the data plane information has been transferred, incoming data traffic links at the destination router can be established and the tunnels between the routers taken down.

### TECHNICAL FIELD

The present invention relates to router migration during network management and, more particularly, to a network-management primitive which allows for (virtual) routers to freely move from one physical node to another without impacting data traffic.

### BACKGROUND OF THE INVENTION

Network management is widely recognized as one of the most important challenges facing the Internet. Indeed, the cost of personnel and systems which manage a network typically exceeds the cost of the underlying nodes and links. Additionally, most network outages are caused by operator errors, rather than equipment failures. From routine tasks such as “planned maintenance” to the less-frequent deployment of new protocols, network operators struggle to provide seamless service in the face of changes to the underlying network. Handling change is difficult because each change to the physical infrastructure requires a corresponding modification to the logical configuration of the routers (e.g., reconfiguring the tunable parameters in the routing protocols).

For the purposes of this discussion, the term “logical” is used to refer to IP packet-forwarding functions, while “physical” refers to the physical router equipment (such as line cards and the CPU) that enables these functions. Any inconsistency between the logical and physical configurations can lead to unexpected reachability or performance problems. Furthermore, because of today's tight coupling between the physical and logical topologies, sometimes logical-layer changes are used purely as a “tool” to handle physical changes more gracefully. A classic example is increasing the link weights in Interior Gateway Protocols to “cost out” a router in advance of planned maintenance. In this case, a change in the logical topology is not the goal, rather, it is the indirect tool available to achieve the task at hand, and it does so with potential negative side effects.

Prior efforts, known as RouterFarm, essentially performs a “cold restart” for virtual routers which are moved from one physical location to another. Specifically, in RouterFarm, router migration is realized by re-instantiating a router instance at a new location, which not only requires router reconfiguration, but also introduces inevitable downtime in both the control and data planes.

Recent advances in virtual machine technologies and their live migration capabilities have been leveraged in server-management tools, primarily in data centers, For example, Sandpiper automatically migrates virtual servers across a pool of physical servers to alleviate hotspots. However, the need remains to apply these live migration capabilities to routers.

### SUMMARY OF THE INVENTION

In accordance with the present invention, a network-management primitive is proposed where virtual routers can move freely from one physical router to another. In particular, physical routers serve only as a carrier substrate on which the virtual routers operate. The primitive of the present invention functions to migrate a virtual router to a different physical router without disrupting the flow of traffic or changing the logical topology, obviating the need to reconfigure the virtual routers while also avoiding routing-protocol convergence delays.

In accordance with the present invention, live router migration is implemented by separating the logical features of the virtual router from the physical features. In the first step, tunnels are established between a source (physical) router and a destination (physical) router, allowing the control plane of virtual router being migrated to send and receive messages from the destination router. The control plane information is then transferred to the destination router, which then functions to clone the data plane at the destination router. Outgoing links from the destination router can then be established. The double appearance of the data plane at both the source and destination routers allows for the data plane information to be transferred asynchronously over to the destination router. Once all of the data plane information has been transferred, incoming data traffic links at the destination router can be established and the tunnels between the routers taken down.

It is an advantage of the present invention that live router migration may be used in situations where a physical router must undergo planned maintenance. In this case, the virtual routers are moved (in advance) to another physical router in the same Point-of-Presence (PoP). Additionally, edge routers can be moved from one location to another by virtually re-homing the links that connect to neighboring domains.

Live router migration is also a useful tool in the deployment of new services by enabling network operators to freely migrate virtual routers from a trial system to the operational backbone. That is, instead of shutting down the trial service (as required in the prior art), the ISP can continue supporting the early-adopter customers while continuously growing their trial systems, attracting new customers and eventually moving the service completely to the operational network.

In today's concerns regarding environmental and energy constraints, the ability to easily and quickly migrate virtual routers in accordance with the present invention also allows for load distribution and the ability to “power down” physical routers during periods of time when the traffic load is relatively light.

These and other aspects of the present invention will become apparent during the course of the following discussion and by reference to the accompanying drawings.

### BRIEF DESCRIPTION OF THE DRAWINGS

FIG. 1 illustrates the architecture of an exemplary virtual router that may be used for live router migration in accordance with the present invention;

FIGS. 2(a)-(d) illustrate the sequential steps performed in live router migration in accordance with the present invention;

FIG. 3 is a timeline illustrating the progression of live router migration in accordance with the present invention; and

FIG. 4 illustrates a prototype implementation of the present invention.

### DETAILED DESCRIPTION

There are three basic building blocks to the live router migration strategy of the present invention: (1) router virtualization; (2) control and data plane separation; and (3) dynamic interface binding. Unlike regular servers, today's routers typically have physically separate “control” and “data” planes. In accordance with the present invention, this unique property is leveraged in the form of a “data-plane hypervisor” between the control and data planes which enables virtual routers to migrate across different data-plane platforms. In particular, three different techniques are used in accordance with the present invention to provide this implementation while minimizing control-plane downtime and eliminating data-plane disruption: (1) data-plane cloning, (2) remote control plane, and (3) double data planes.

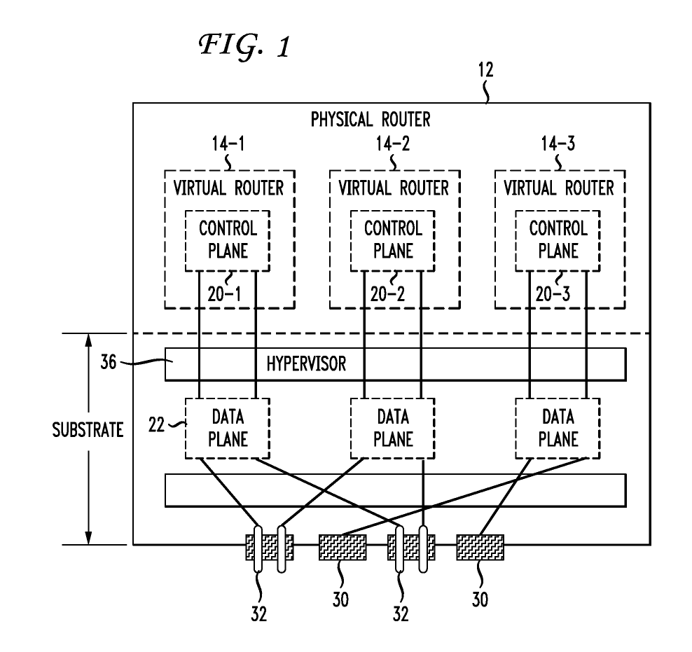

FIG. 1 illustrates the architecture of an exemplary virtual router which can be used for live router migration in accordance with the present invention. As will be discussed in detail below, a virtual router comprises the three separate features described above which allow for live router migration to be achieved. In particular, “router virtualization” is achieved by partitioning the resources of physical router 12 to support multiple “virtual router” instances. Referring to the exemplary embodiment of FIG. 1, a physical router 12 is shown as supporting a plurality of virtual routers 14-1, 14-2 and 14-3. Each virtual router includes its own control plane 20 (e.g., applications, configurations, routing protocol instances and a routing information based (RIB)) and data plane 22 (e.g., interfaces and a forwarding information base (FIB)). The isolation between virtual routers 14-1, 14-2, and 14-3 makes it possible to migrate one virtual router (for example, virtual router 14-2) without affecting the remaining routers (for example, virtual routers 14-1 and 14-3).

As also shown in FIG. 1, within each virtual router, control plane 20 and data plane 22 run in separate environments, divided by a physical interface. As indicated by the dotted lines, control planes 20 of each virtual router 14-1, 14-2 and 14-3 are hosted in separate “containers” 26 (also referred to as “virtual environments”, VE) while their respective data planes 22 reside in substrate 28, where each data plane 22 is kept in separate data structures with its own state information (such as FIB entries and access control lists (ACLs)). This separation between the logical VE 26 and physical substrate 28 allows for virtual routers of the present invention to migrate control planes 20 and data planes 22 separately in a manner to be discussed in detail hereinbelow.

To enable router migration and link migration, a virtual router of the present invention needs to be able to dynamically set up and change the binding between the virtual routers FIB (stored in data plane 22) and its various substrate interfaces, shown in FIG. 1 as including both physical interfaces 30 and tunnel interfaces 32. Given the existing interface binding mechanism in today's routers that maps interfaces with virtual routers, the virtual router live migration scheme of the present invention requires only two simple extensions. First, after a virtual router is migrated, the binding needs to be re-established dynamically on the new physical router—in actuality, this is no different than if the virtual router were first being instantiated on the new physical router. Second, link migration in a packet-aware transport network involves changing tunnel interfaces in the router. In this case, the router substrate needs to switch the binding from the old tunnel interface to the new one on the fly. Alternatively, with a programmable transport network, link migration happens inside the transport network and is transparent to the routers.

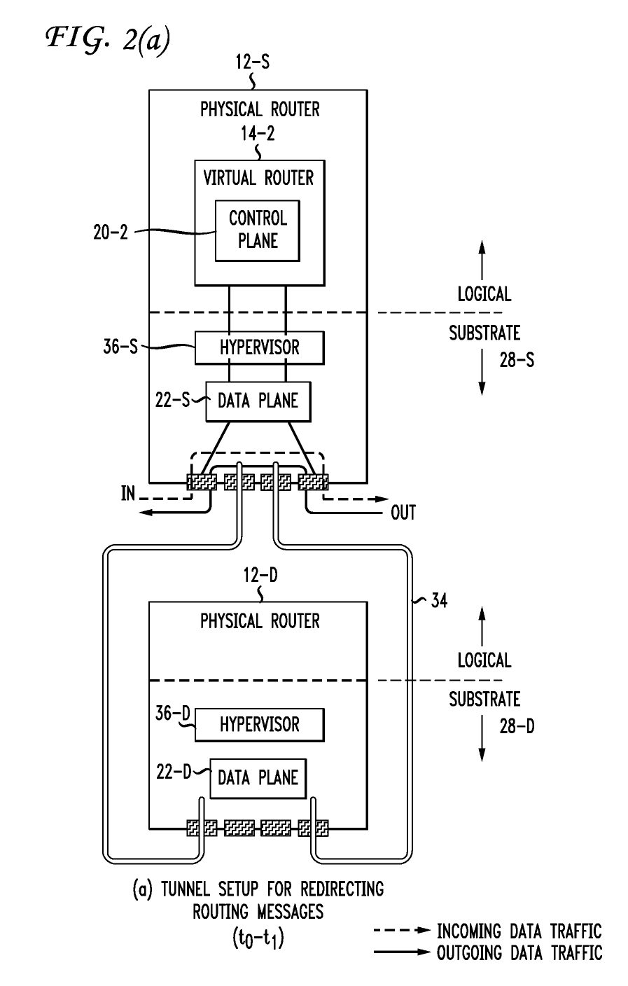

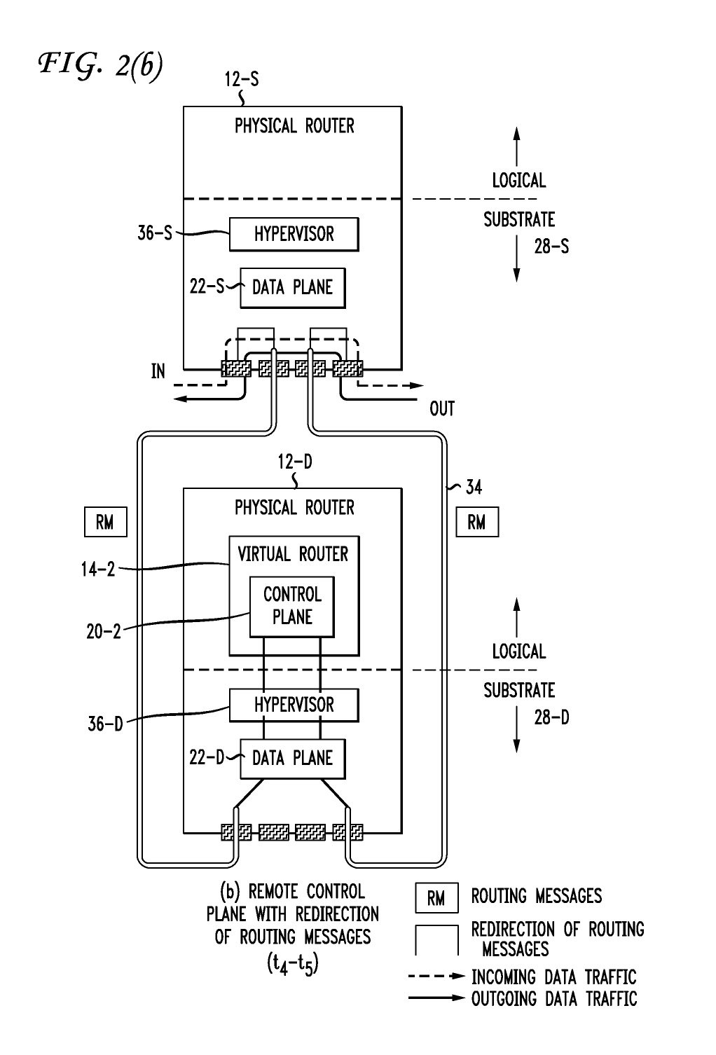

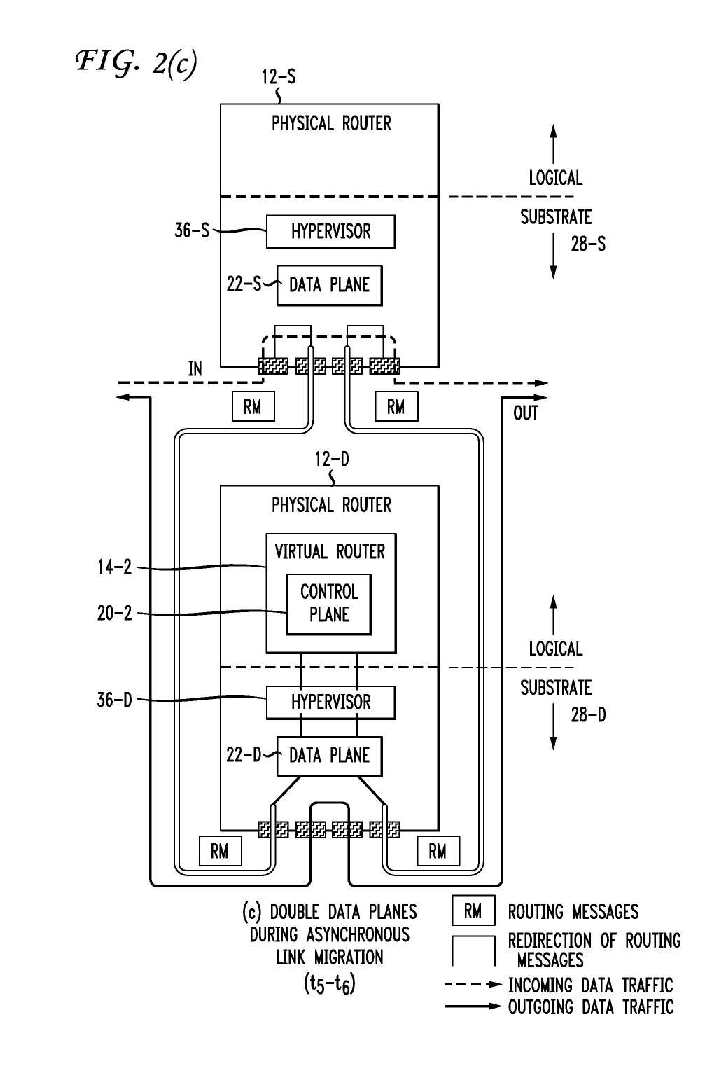

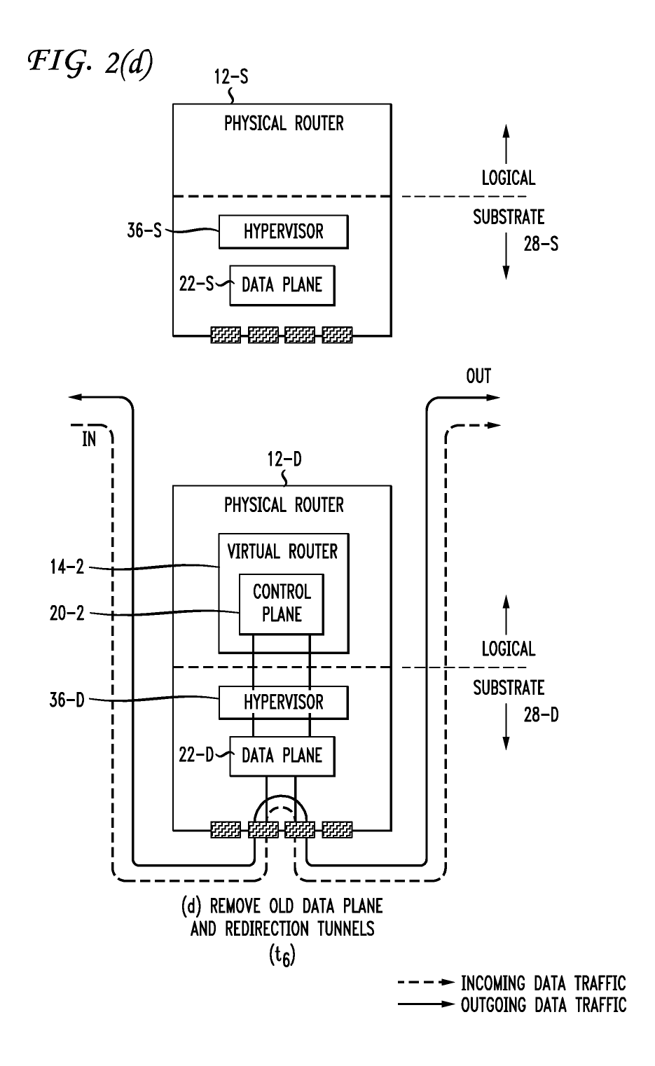

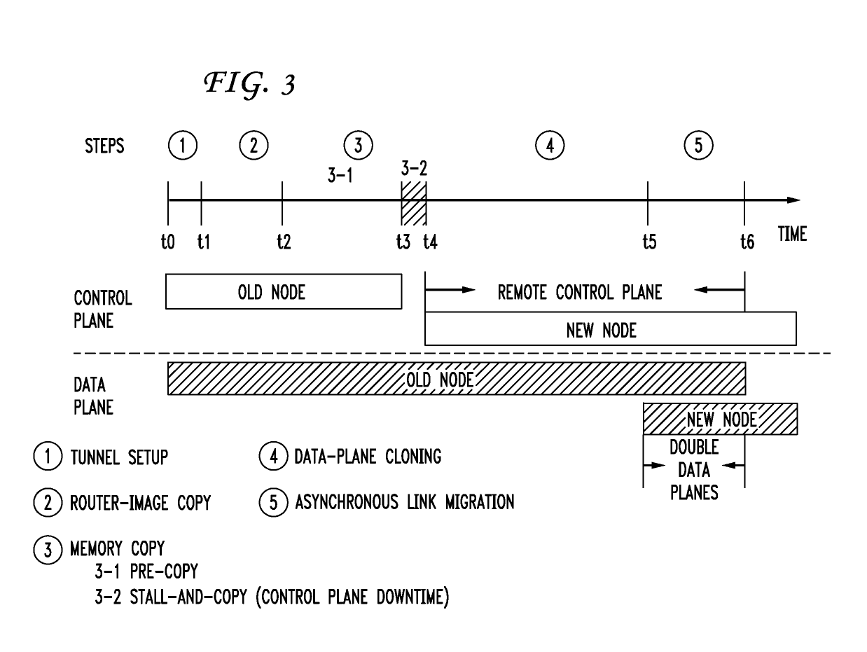

FIGS. 2(a)-(d), in conjunction with the timeline of FIG. 3, illustrate the live virtual router migration process of the present invention, in this example associated with the live migration of virtual router 14-2 (as shown in FIG. 1). Referring to FIG. 2(a), the first step in the process involves establishing tunnels 34 between the “source” physical router (shown in this case as physical router 12-S) and the “destination” physical router (shown in this case as physical router 12-D). These tunnels 34 allow control plane 20-2 to send and receive routing messages after it is migrated to router 12-D even before link migration is completed. Tunnels 34 also allow the migrated control plane 20-2 to keep its data plane 22-S on router 12-S up to date. Although control plane 20-2 will experience a short period of downtime (during time period t3-t4, related to memory copy), data plane 22-S continues working during the entire migration process. In fact, after performing the data-plane cloning operation, data planes 22-S and 22-D on routers 12-S and 12-D, respectively, can forward traffic simultaneously, as shown in FIG. 2(c). In accordance with the present invention, therefore, the presence of these double data planes allows for the links to be migrated in asynchronous fashion from router 12-S to router 12-D, after which data plane 22-S on router 12-S is disabled, as shown in FIG. 2(d). The following paragraphs will describe the various steps in the process, as outlined in FIGS. 2(a)-(d), in greater detail.

In the first instance, as discussed above, tunnels 34 are created between source router 12-S and destination router 12-D, providing routing message communication paths from control plane 20-2 of virtual router 14-2 to physical ports on substrate 28-D of destination router 12-D to support the migration of control plane 20-2. While these tunnels are established, it is shown in FIG. 2(a) that both incoming and outgoing data traffic are still passing through source router 12-S.

Two things need to be taken care of when migrating control plane 20-2: (1) the “router image” (such as routing-protocol binaries and network configuration files) and (2) the “memory” (which includes the states of all the running processes). When copying the router image and memory, it is desirable to minimize the total migration time and, more importantly, to minimize the down time of control plane 20-2 (that is, the time between when control plane 20-2 is check-pointed on a source node and restored on a destination node). This is because although routing protocols can usually tolerate a brief network glitch using retransmission (e.g., BGP uses TCP retransmission, while OSPF uses its own reliable retransmission mechanism), a long outage at control plane 20-2 can break protocol adjacencies and cause protocols to reconverge.

In accordance with the present invention, it is presumed that the same set of binaries are already available on every physical router in the network. Before a virtual router is migrated in accordance with the present invention, the binaries are locally copied to its file system on destination router 12-D. Therefore, only the router configuration files need to be copied over the network, reducing the total migration time (as a “local copy” process is usually faster than a “network copy” process).

The simplest way to migrate the memory of a virtual router is to checkpoint the router, copy the memory pages to the destination physical router and restore the originating router (this process is also referred to as “stall and copy”). This approach leads to down time that is proportional to the memory size of the router. A better approach is to add an iterative pre-copy phase before the final stall-and-copy, as shown in the timeline of FIG. 3. All pages are transferred in the first round of the pre-copy phase, and in the following rounds, only pages there were modified during the previous round are transferred. This pre-copy technique reduces the number of pages that need to be transferred in the stall-and-copy phase, reducing the down time of control plane 20-2 in virtual router 14-2 (that is, control plane 20-2 is only “frozen” between times t3 and t4 as shown in the timeline of FIG. 3).

The cloning of data plane 22-S will next be described. The live migration process of the present invention utilizes a novel data plane “hypervisor” 36 (shown in FIG. 1) which allows a migrated control plane 20-2 to re-instantiate its associated data plane 22-S on the new network (appearing as data plane 22-D on destination physical router 12-D), using a technique referred to as data plane cloning. That is, only control plane 20-2 of virtual router 14 is actually migrated. Once control plane 20-2 is migrated to destination physical router 12-D, as shown in FIG. 2(b), it “clones” its original data plane by repopulating the FIB using its RIB and reinstalling ACLs and other data-plane states through data plane hypervisor 36. Indeed, data plane hypervisor 36 provides a unified interface to control plane 20-2 that hides the heterogeneity of the underlying data plane implementations (i.e., instantiations of both data planes 22-S and 22-D), enabling virtual routers to migrate between different types of data planes. At this point, while the routing messages are being forwarded to destination router 12-D, all incoming and outgoing data traffic remains associated with source router 12-S.

As shown in FIG. 2(c), after control plane 20-2 of virtual router 14 is migrated from physical router 12-S to physical router 12-D, the natural next steps are to repopulate (clone) data plane 22-S on router 12-D (forming data plane 22-D) and then migrate the links from router 12-S to router 12-D. Unfortunately, the creation of a new data plane 22-D cannot be accomplished instantaneously, primarily due to the time it takes to install FIB entries. Installing one FIB entry typically takes between one hundred and a few hundred microseconds; therefore, installing the full Internet BGP routing table (about 250,000 routes) could take over 20 seconds. During this period of time, although data traffic can still be forwarded by original data plane 22-S on physical source router 12-S, all the routing instances in control plane 20-2 of virtual router 14-2 can no longer send or receive routing messages. The longer control plane 20-2 remains unreachable, the more likely it will lose its protocol adjacencies with its neighbors.

To overcome this problem, substrate 28-S of router 12-S begins redirecting all routing messages destined for virtual router 14-2 to physical destination router 12-D at the end of the control plane migration process (shown as time t4 in the graph of FIG. 3.) With this redirection, control plane 20-2 of virtual router 14-2 can not only exchange routing messages with its neighbors, it can also function as a “remote control plane” for its old data plane 22-S on physical source router 12-S and continue to update the old FIB when routing changes occur.

In theory, after the data plane cloning step shown in FIG. 2(c), virtual router 14-2 can switch from the old data plane 22-S on source router 12-S to the new data plane 22-D on destination router 12-D by simultaneously migrating all of its links from router 12-S to router 12-D. However, performing accurate synchronous link migration across all links is challenging, and may significantly increase the cost and complexity of the network system (associated with the need to implement a network-wide synchronization mechanism).

In accordance with the present invention, however, inasmuch as virtual router 14-2 has two separate data planes 22-S and 22-D (on routers 12-S and 12-D, respectively) ready to forward traffic at the end of the data plane cloning step, the migration of its links does not need to occur all at once. Instead, each link can be migrated independently of all of the others, in an asynchronous fashion as shown in FIGS. 2(c) and (d). First, destination router 12-D creates a new outgoing link to each of virtual router 14-2′s neighbors, while all incoming data traffic continues to flow through physical source router 12-S. Afterward, incoming data traffic can be safely migrated asynchronously, with some traffic starting to flow through destination router 12-D, while the remaining traffic still flows through source router 12-S. Finally, once all of the links associated with virtual router 14-2 are migrated to destination router 12-D, the old data plane 22-S and outgoing links on source router 12-S, as well as temporary tunnels 34, can be safely removed, as shown in FIG. 2(d).

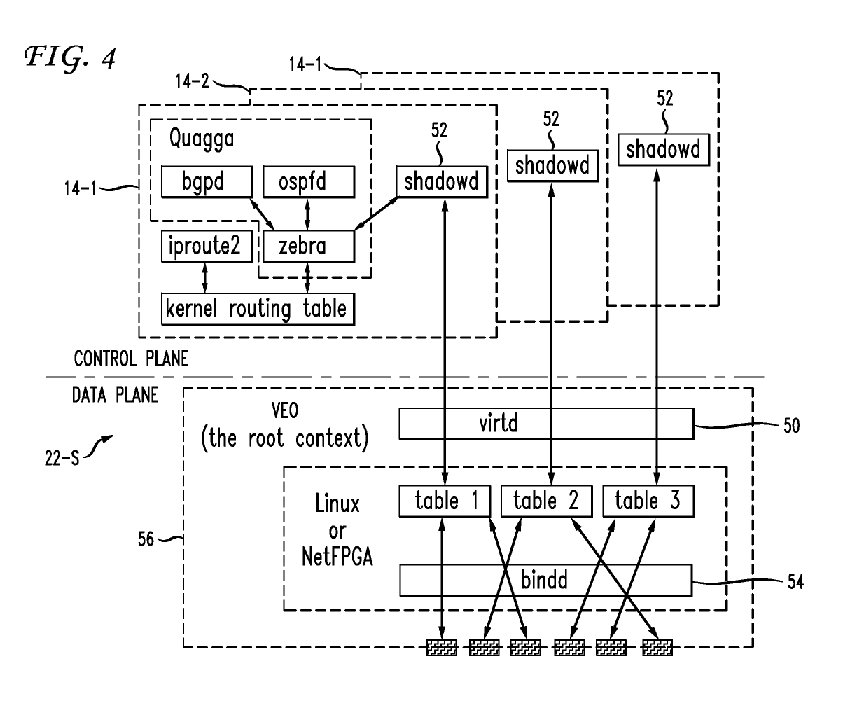

A prototype implementation of the present invention consists of three new programs, as shown in FIG. 4. These include “virtd” 50, to enable packet forwarding outside of the virtual environment (e.g., separation of control plane 20 from data plane 22), “shadowd” 52, to enable each virtual router to install routes into the FIB; and “bindd” 54 (data plane cloning), to provide the bindings between the physical interfaces and the virtual interfaces and FIB of each virtual router (data-plane hypervisor 36).

To mimic the process of separating control plane 20 from data plane 22, the FIBS are first moved out of each virtual router and placed in a shared—but virtualized—data plane 22-S, as shown in FIG. 4 for virtual routers 14-1, 14-2 and 14-3. This means that packet forwarding no longer happens within the separate bounds of each virtual router, so that it remains unaffected when the selected virtual (such as virtual router 14-2) is migrated.

As previously mentioned, it is possible to use two different methods to implement the live router migration process of the present invention—a software-based data plane (SD) method and a hardware-based data plane (HD) method. For the SD prototype router, data plane 22 resides in root context 56 (or “VEO”) of the system and uses the Linux kernel for packet forwarding. Since the Linux kernel supports 256 separate routing tables, the SD router virtualizes its data plane 22 by associating each virtual router 14-1, 14-2 and 14-3 with a different kernel routing table as its FIB, shown as table1, table2 and table3 in VEO 56 of FIG. 4.

As discussed above, live virtual router migration in accordance with the present invention extends the standard control plane/data plane interface to a migration-aware data-plane hypervisor. As shown in FIG. 4, program vitrd 50 runs in VEO 56 and provides an interface for virtual routers to install/remove routes in shared data plane 22-S. As also shown, program shadowd 52 runs inside each virtual router 14-1, 14-2 and 14-3, and pushes route updates from shared control plane 20-S to the FIB through program vitrd 50. As shadowd 52 is not a routing protocol but simply a shadowing daemon, it uses only the route redistribution capability. Through this interface, program shadowd 52 is notified of any changes in the RIB and immediately mirrors them to program vitrd 50 using remote procedure calls (RPCs). Each instance of shadowd 52 in virtual routers 14-1, 14-2 and 14-3 is configured with a unique ID, which is included in every message it sends to virtd 50. Based on this ID, virtd 50 can correctly install/remove routes in the corresponding FIB upon receiving updates from a specific shadowd 52.

With this separation of control plane 20 and data plane 22, and the sharing of the same data plane 22-S among a plurality of virtual routers, the data path is required to be set up properly to ensure that data packets can be forwarding according to the right FIB, and that routing messages can be delivered to the proper control plane 20. In accordance with the present invention, program bindd 54 meets these requirements by providing two main functions. The first is to set up the mapping between a virtual router's substrate interfaces and its FIB after a virtual router has been instantiated (or migrated) in a new physical router, to ensure for correct packet forwarding. In the SD prototype, program bindd 54 establishes this binding by using the routing policy management function (i.e., “ip rule”) provided by the Linux “iproute 2” utility. As previously mentioned, the HD prototype is currently limited to a single table.

The second function of program bindd 54 is to bind the substrate interfaces with the virtual interfaces of the control plane. This binding is achieved (for both SD and HD implementations) by connecting each pair of substrate and virtual interfaces to a different bridge using the Linux “brctl” utility.

Summarizing, live virtual router migration in accordance with the process of the present invention is provided by a new network management primitive which allows a virtual router to be moved from one physical router to another. In implementation, the migrated control plane “clones” the state of its data plane at the new location while continuing to update the state at the old location. The method of the present invention temporarily forwards packets using both data planes to support asynchronous migration of the links. These designs are readily applicable to commercial router platforms. It has been demonstrated that the process of the present invention does not disrupt the data plane, and only briefly freezes the control plane.

The live virtual router migration technique of the present invention not only provides a simple solution to conventional network management tasks, but also enables new solutions to emerging challenges such as power management. It was reported that in the year 2000, the total power consumption of the estimated 3.26 million routers in the United States was about 1.1 TWh (Tera-Watt hours). This number is expected to grow to 1.9 to 2.4 TWh over the next few years, which translates into an annual cost of about $175-255 million.

Although designing energy-efficient equipment is an important part of the solution to power savings, it is believed that network operators also have an opportunity to manage a given network in a power-efficient manner. Previous studies have reported that Internet traffic has a consistent “wave” shape diurnal pattern that caused by human interactive network activities.

By implementing the migration technique of the present invention, variations in daily traffic volume can be exploited to reduce power consumption. Specifically, the size of the physical network can be expanded and shrunk according to traffic demand, by hibernating or powering-down the routers that are not needed. In particular, as the network traffic volume decreases (usually overnight), virtual routers can be migrated to a smaller set of physical routers and the “empty” physical routers can be shut down to save power. When the traffic starts to increase, physical routers can be brought back on line as necessary and virtual routers migrated back accordingly. Advantageously, the IP-layer topology stays intact during the migration process of the present invention, so that these power savings do not come at the price of user traffic disruption, reconfiguration overhead or protocol reconvergence.

Other network management benefits of live router migration in accordance with the present invention include the ability to easily migrate virtual routers away from a physical router scheduled for planned maintenance, and to expand the deployment of a new service without the need to first shutting down a trial operation. With respect to planned maintenance, network administrators can simply migrate all the virtual routers running on a physical router to other physical routers before doing maintenance and migrate them back afterwards as needed, without ever needing to reconfigure any routing protocols or worry about traffic disruption or protocol reconvergence. In the deployment of new services, the live router migration technique of the present invention by enabling network operators to freely migrate virtual routers from the trial system to the operational backbone. Rather than shutting down the trial service, the ISP can continue supporting the early-adopter customers while continuously growing their trial system, attracting new customers and eventually moving the service completely to the operational network.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of migrating a virtual router from a first physical router to a second physical router, the virtual router partitioned so as to separate its control plane from its data plane, the method comprising the steps of:
a) establishing tunnel links between the first physical router and the second physical router;
b) transmitting routing messages over the tunnels created in step b);
c) migrating the control plane of the virtual router to the second physical router;
d) asynchronously migrating links from the first physical router to the second physical router to create a cloned data plane at the second physical router; and
e) removing the data plane and tunnel links at the first physical router.

2. The method as defined in claim 1 wherein the first physical router and the second physical router are located at the same POP.

3. The method as defined in claim 1 wherein the first physical router and the second physical router are located at different POPs.

4. The method as defined in claim 1 wherein the first physical router supports a plurality of separate virtual routers.

5. The method as defined in claim 4 wherein a single virtual router is migrated from the first physical router to the second physical router.

6. The method as defined in claim 4 wherein the plurality of separate virtual routers are migrated away from the first physical router so as to allow for the first physical router to be scheduled for maintenance.

7. The method as defined in claim 6 wherein the method further comprises the step of migrating the plurality of virtual routers back to the first physical router at the completion of the maintenance process.

8. The method as defined in claim 4 wherein the plurality of separate virtual routers are migrated away from the first physical router during periods of low demand such that the physical router can be hibernated.
